(19) United States
(12) Patent Application Publication
(10) Pub. No.: US 2025/0213426 A1
(43) Pub. Date: Jul. 3, 2025

(54) LEG-AND-FOOT DEVICE AND MASSAGE CHAIR

(71) Applicant: Shanghai Rongtai Health Technology Corporation Limited, Shanghai (CN)

(72) Inventors: Guohui Li, Shanghai (CN); Junliang Wang, Shanghai (CN); Qi Lin, Shanghai (CN)

(21) Appl. No.: 18/900,856

(22) Filed: Sep. 29, 2024

(30) Foreign Application Priority Data
Dec. 29, 2023 (CN) 2023118680441

(51) Int. Cl. A61H 23/02

(52) U.S. Cl. CPC A61H 23/0254; A61H 2201/0149; A61H 2201/0196; A61H 2205/106; A61H 2205/12

(57) ABSTRACT

A leg-and-foot device capable of being driven solely contains: a base, a left leg-and-foot massage portion, a right leg-and foot massage portion, a first left drive element and a first right drive element which are connected on the base. A driving segment of the first left drive element is connected with the left leg-and foot massage portion and is configured to drive the left leg-and-foot massage portion to stretch and retract with respect to the base. A driving segment of the first right drive element is connected with the right leg-and foot massage portion and is configured to drive the right leg-and-foot massage portion to stretch and retract with respect to the base.

### TECHNICAL FIELD

The present invention relates to sports and massage equipment, and more particularly to a leg-and-foot device and a massage chair which are driven solely.

### BACKGROUND

In recent years, as the pace of life continues to accelerate, sub-health problems have become increasingly prominent, and people's demand for massage to eliminate fatigue is also increasing. Manual massage is difficult to popularize into people's daily lives due to limitations in venue, cost and professionalism of personnel. Smart massage chairs are increasingly recognized by the public because they can use fragmented time, can be used at home and are low-cost.

Smart massage chairs usually include main trunk massage devices for the user's head, shoulders, back, buttocks, hands, legs and feet. In particular, because the legs and feet need to support the weight of the human body, they are prone to fatigue in people's daily lives. Therefore, the research on continuously improving massage devices for the legs and feet has become a main research direction for those skilled in the field.

At present, most leg and foot massage devices on the market use a relatively fixed method to massage the left and right legs and feet at the same time. However, in actual scenarios, many users have concerns about the stretching length, massage movements and massage of the left and right legs and feet. Each location has different requirements.

The present invention has arisen to mitigate and/or obviate the afore-described disadvantages.

### SUMMARY

The primary aspect of the present invention is to provide a leg-and-foot device and a massage chair which is configured to stretch user's legs and feet based on customized using requirements.

To obtain above-mentioned aspects, a leg-and-foot device capable of being driven solely provided by the present invention contains: a base, a left leg-and-foot massage portion, a right leg-and foot massage portion, a first left drive element and a first right drive element which are connected on the base.

A driving segment of the first left drive element is connected with the left leg-and foot massage portion and is configured to drive the left leg-and-foot massage portion to stretch and retract with respect to the base. A driving segment of the first right drive element is connected with the right leg-and foot massage portion and is configured to drive the right leg-and-foot massage portion to stretch and retract with respect to the base.

Preferably, the first left drive element includes a left-moving drive motor, a left screw rod connected with the left-moving motor, and a left screw mating with the left screw rod. The left leg-and-foot massage portion is mounted on the left screw; the first right drive element includes a right-moving drive motor, a right screw rod connected with the right-moving drive motor, and a right screw mating with the right screw rod. The right leg-and-foot massage portion is mounted on the right screw.

Preferably, the leg-and-foot device further contains at least one control element which is electrically connected with the first left drive element and the first right drive element to control the left leg-and-foot massage portion and/or the right leg-and-foot massage portion to move.

Preferably, the at least one control element includes a control unit, a left leg-and-foot length sensing unit and a right leg-and-foot sensing unit. The control unit is electrically connected with the left leg-and-foot length sensing unit, the right leg-and-foot sensing unit, the first left drive element, and the second right drive element. The left leg-and-foot length sensing unit is connected on the left leg-and-foot massage portion and is configured to sense a length of the user's left leg, and the right leg-and-foot length sensing unit is connected on the right leg-and-foot massage portion and is configured to sense a length of the user's right leg.

Preferably, the left leg-and-foot massage portion includes a left leg massager and a left foot massager, and the right leg-and-foot massage portion includes a right leg massager and a right foot massager.

The leg-and-foot device further contains a second left drive element and a second right drive element. A driving segment of the second left drive element is connected with the left foot massager so as to drive the left foot massager to swing vertically or rotate with respect to the base. A driving segment of the second right drive element is connected with the right foot massager so as to drive the right foot massager to swing vertically or rotate with respect to the base.

Preferably, the at least one control element includes a control unit, a left-foot angle sensing unit and a right-foot angle sensing unit. The control unit is electrically connected with the left-foot angle sensing unit, the right-foot angle sensing unit, the second left drive element, and the second right drive element. The left-foot angle sensing unit is disposed on the left foot massager to sense an angle between an axial line of the left foot massager and an axial line of the left leg massager, and the right-foot angle sensing unit is disposed on the right foot massager to sense an angle between the an axial line of the right foot massager and an axial line of the right leg massager.

Preferably, the left leg-and-foot massage portion and the right leg-and-foot massage portion respectively include at least one massaging element.

Preferably, one of the base and the left leg-and-foot massage portion includes a left slide rail, and the other of the base and the left leg-and-foot massage portion includes a left receiving groove mating with the left slide rail. One of the base and the right leg-and-foot massage portion includes a right slide rail, and the other of the base and the right leg-and-foot massage portion includes a right receiving groove mating with the right slide rail.

Preferably, a massage chair contains a body and the leg-and-foot device of claim connected on the body.

Preferably, the body includes a holder and a seat rotatably connected on the holder, and the leg-and-foot device is rotatably connected on the seat. The massage chair further includes a push assembly disposed on the holder and configured to drive the seat to rotate with respect to the holder and/or configured to drive the leg-and-foot device to rotate relative to the seat.

### BRIEF DESCRIPTION OF THE DRAWINGS

FIG. 1 is a perspective view showing the assembly of a leg-and-foot device according to a preferred embodiment of the present invention.

FIG. 2 is a side plan view showing the assembly of the leg-and-foot device according to the preferred embodiment of the present invention.

FIG. 3 is a perspective view showing the operation of the leg-and-foot device according to the preferred embodiment of the present invention.

FIG. 4 is a side plan view showing the operation of the leg-and-foot device according to the preferred embodiment of the present invention.

FIG. 5 is another side plan view showing the operation of the leg-and-foot device according to the preferred embodiment of the present invention.

FIG. 6 is a side plan view showing the assembly of a part of the leg-and-foot device according to the preferred embodiment of the present invention.

FIG. 7 is a perspective view showing the leg-and-foot device being connected with a massage chair according to the preferred embodiment of the present invention.

### DETAILED DESCRIPTION

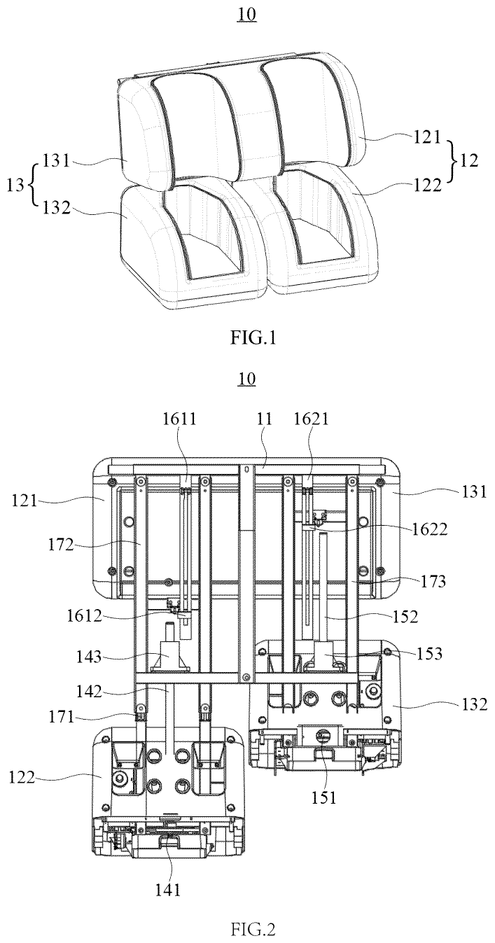

With reference to FIGS. 1 and 2, a leg-and-foot device 10 capable of being driven solely according to a preferred embodiment of the present invention is driven solely and comprises: a base 11, a left leg-and-foot massage portion 12, a right leg-and foot massage portion 13, a first left drive element and a first right drive element which are connected on the base 11, wherein a driving segment of the first left drive element is connected with the left leg-and foot massage portion 12 and is configured to drive the left leg-and-foot massage portion 12 to stretch and retract with respect to the base 11, and a driving segment of the first right drive element is connected with the right leg-and foot massage portion 13 and is configured to drive the right leg-and-foot massage portion 13 to stretch and retract with respect to the base 11.

The left leg-and-foot massage portion 12 is configured to massage a user's left leg and foot, and the right leg-and-foot massage portion 13 is configured to massage a user's right leg and foot. The left leg-and-foot massage portion 12 and the right leg-and-foot massage portion 13 respectively include at least one cavity configured to massage and accommodate a user's limbs.

The first left drive element is disposed on the base 11 and has a first driving segment which moves reciprocately along a length direction (i.e. the user's left leg) of the left leg-and-foot massage portion 12, the left leg-and-foot massage portion 12 is connected and moves with the first driving segment. A second right drive element is disposed on the base 11 and has a second driving segment which moves reciprocately along a length direction (i.e. the user's right leg) of the right leg-and-foot massage portion 13, and the right leg-and-foot massage portion 13 is connected and moves with the second driving segment. After the left leg-and-foot massage portion 12 and the right leg-and-foot massage portion 13 are driven, they move linearly back and forth with respect to the base 11 to stretch and retract solely, thus massaging and stretching the user's right leg and foot and left leg and foot based on customized using requirements.

In this embodiment, the structures of the left leg-and-foot massage portion 12 and the right leg-and-foot massage portion 13 are not limited, as long as they can massage the user's legs and feet. The structures of the first left drive element and the first right drive element are not limited, as long as they can respectively drive the left leg-and-foot massage portion 12 and the right leg-and-foot massage portion 13 to reciprocately move linearly relative to the base 11

The left leg-and-foot massage portion 12 includes a left leg massager 121 and a left foot massager 122, and the right leg-and-foot massage portion 13 includes a right leg massager 131 and a right foot massager 132, wherein the left foot massager 122 is connected with the driving segment of the first left drive element, and the right foot massager 132 is connected with the driving segment of the first right drive element.

The left leg massager 121, the right leg massager 131, the left foot massager 122, and the right foot massager 132 are respectively configured to massage the user's left leg, right leg, left foot, and right foot. Preferably, the left leg massager 121, the right leg massager 131, the left foot massager 122, and the right foot massager 132 respectively has a cavity configured to massage and accommodate the user's left leg, right leg, left foot, and right foot.

The left leg massager 121 and the right leg massager 131 are one-piece formed and connected on the base 11 and do not stretch and retract with the left foot massager 122 and the right foot massager 132 respectively. Alternatively, the left leg massager 121 is connected with the left foot massager 122 to stretch and retract with the left foot massager 122, and the right leg massager 131 is connected with the right foot massager 132 to stretch and retract with the right foot massager 132.

The first left drive element includes a left-moving drive motor 141, a left screw rod 142 connected with the left-moving motor 141, and a left screw 143 mating with the left screw rod 142, wherein the left leg-and-foot massage portion 12 is mounted on the left screw 143. The first right drive element includes a right-moving drive motor 151, a right screw rod 152 connected with the right-moving drive motor 151, and a right screw 153 mating with the right screw rod 152, wherein the right leg-and-foot massage portion 13 is mounted on the right screw 153.

The left screw rod 142 is connected with an output shaft of the left-moving drive motor 141, and the output shaft of the left-moving drive motor 141 actuates the left screw rod 142 to rotate. The left screw 143 is fitted on and screwed with the left screw rod 142, the left screw rod 142 rotates forward or reversely to drive the left screw 143 to move linearly forward or reversely. The left leg-and-foot massage portion 12 is fixed on the left screw 143 to move reciprocately along an axial line of the left screw rod 142, wherein the axial line of the left screw rod 142 is parallel to a length direction (i.e. the user's left leg) of the left leg-and-foot massage portion 12. The movement of the right leg-and-foot massage portion 13 is identical to the movement of the left leg-and-foot massage portion 12, so further remarks are omitted.

The leg-and-foot device 10 further comprises at least one control element which is electrically connected with the first left drive element and the first right drive element to control the left leg-and-foot massage portion 12 and/or the right leg-and-foot massage portion 13 to move.

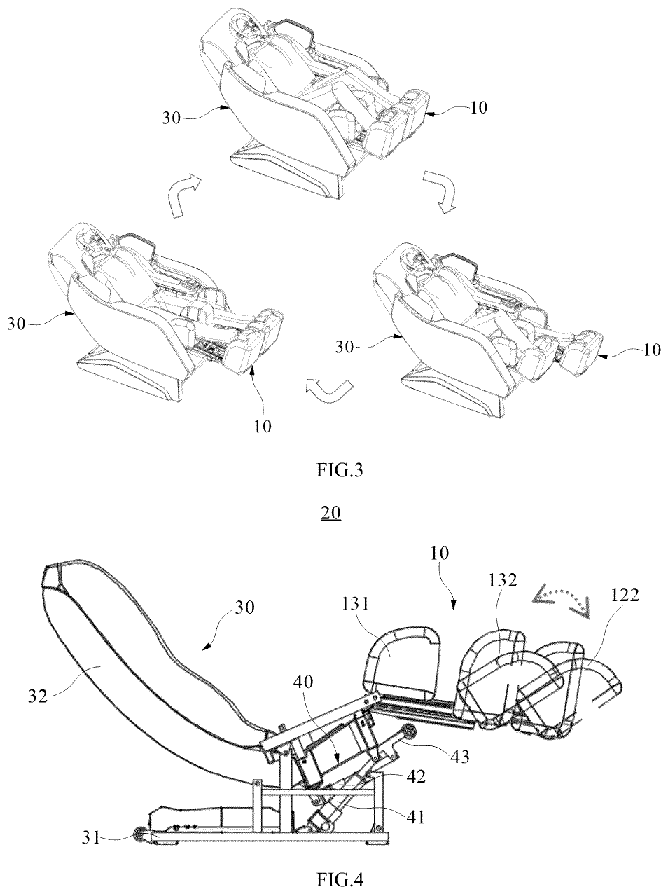

The at least one control element is configured to control the first left drive element and the first right drive element to move solely so as to actuate the left leg-and-foot massage portion 12 and the right leg-and-foot massage portion 13 to stretch and retract synchronously or asynchronously as shown in FIG. 3, thus stretching and retracting the user's legs.

The at least one control element includes a control unit, a left leg-and-foot length sensing unit and a right leg-and-foot sensing unit, wherein the control unit is electrically connected with the left leg-and-foot length sensing unit, the right leg-and-foot sensing unit, the first left drive element, and the second right drive element. The left leg-and-foot length sensing unit is connected on the left leg-and-foot massage portion 12 and is configured to sense a length of the user's left leg, and the right leg-and-foot length sensing unit is connected on the right leg-and-foot massage portion 13 and is configured to sense a length of the user's right leg.

Thereby, the left-leg length sensing unit gathers length parameters of the user's left leg and foot and positional parameters of a moving path, when massaging the left leg-and-foot massage portion 12, then the left-leg length sensing unit sends the length parameters of the user's left leg and foot and the positional parameters of the moving path to the control unit so that the control unit determines to move the left leg-and-foot massage portion 12 along the user's left leg, and the first left drive element is driven by a program. A control process of the first right drive element is identical to a control process of the first left drive element, so further remarks are omitted. The control unit is configured to control at least one of the left leg-and-foot massage portion 12 and the right leg-and-foot massage portion 13 to move along the user's left and right legs upward and downward, thus stretching and retracting the user's left and right legs synchronously or asynchronously based on the customized using requirements.

The left-leg length sensing unit includes a left code strip 1611 and a left length sensor 1612, wherein the left strip 1611 is disposed on the base 11 and stretches along the length direction of the left leg-and-foot massage portion 12, and the left length sensor 1612 is fixed on and moves with the left leg-and-foot massage portion 12 vertically along the left strap 1611, such that a left encoder calculates a vertical moving positions of the left leg-and-foot massage portion 12, the control unit analyzes and processes the positional parameters of the vertical moving positions of the left leg-and-foot massage portion 12, thus controlling a movement to a fixed position of the left leg-and-foot massage portion 12 in a fixed time. The right-leg length sensing unit includes a right code strip 1621 and a right length sensor 1622, wherein the right strip 1621 is disposed on the base 11 and stretches along the length direction of the right leg-and-foot massage portion 13, and the right length sensor 1622 is fixed on and moves with the right leg-and-foot massage portion 13 vertically along the right strap 1621, such that a right encoder calculates a vertical moving positions of the right leg-and-foot massage portion 13, the control unit analyzes and processes the positional parameters of the vertical moving positions of the right leg-and-foot massage portion 13, thus controlling a movement to a fixed position of the right leg-and-foot massage portion 13 in a fixed time.

Referring to FIG. 2, one of the base 11 and the left leg-and-foot massage portion 12 includes a left slide rail 171, and the other of the base 11 and the left leg-and-foot massage portion 12 includes a left receiving groove 172 mating with the left slide rail 171. One of the base 11 and the right leg-and-foot massage portion 13 includes a right slide rail, and the other of the base 11 and the right leg-and-foot massage portion 13 includes a right receiving groove 173 mating with the right slide rail.

The left slide rail 171 is slidably accommodated in the left receiving groove 172 to maintain a stability of a vertical movement of the left leg-and-foot massage portion 12 relative to the base 11. The right slide rail is slidably accommodated in the right receiving groove 173 to maintain a stability of a vertical movement of the right leg-and-foot massage portion 13 relative to the base 11.

As shown in FIG. 1, the left leg-and-foot massage portion 12 includes the left leg massager 121 and the left foot massager 122, and the right leg-and-foot massage portion 13 includes the right leg massager 131 and the right foot massager 132. With reference to FIGS. 4 and 5, the leg-and-foot device 10 further comprises a second left drive element and a second right drive element, wherein a driving segment of the second left drive element is connected with the left foot massager 122 so as to drive the left foot massager 122 to swing vertically or rotate clockwise or counterclockwise with respect to the base 11. A driving segment of the second right drive element is connected with the right foot massager 132 so as to drive the right foot massager 132 to swing vertically or rotate clockwise or counterclockwise with respect to the base 11.

The second left drive element and the second right drive element respectively actuate the left foot massager 122 and the right foot massager 132 to swing or rotate synchronously or non-synchronously, thus massaging the user's left and right foot based on customized using requirements.

In another embodiment, the at least one control element includes a control unit, a left-foot angle sensing unit and a right-foot angle sensing unit, wherein the control unit is electrically connected with the left-foot angle sensing unit, the right-foot angle sensing unit, the second left drive element, and the second right drive element. The left-foot angle sensing unit is disposed on the left foot massager 122 to sense an angle between an axial line of the left foot massager 122 and an axial line of the left leg massager 121, and the right-foot angle sensing unit is disposed on the right foot massager 132 to sense an angle between an axial line of the right foot massager 132 and an axial line of the right leg massager 131.

Thereby, the left-foot angle sensing unit gathers angular parameters between the axial line of the left foot massager 122 and the axial line of the left leg massager 121, then the left-foot angle sensing unit send the angular parameters to the control unit so that the second left drive element is driven by the program to swing vertically or rotate clockwise or counterclockwise. A control process of the second right drive element is identical to the control process of the second left drive element, so further remarks are omitted.

The control unit is configured to control at least one of the left foot massager 122 and the right foot massager 132 to swing, rotate or swing and rotate the user's left and right ankle synchronously or asynchronously based on the customized using requirements. The second left drive element and the second right drive element are electrically connected with the control unit respectively to move the left or right ankle solely.

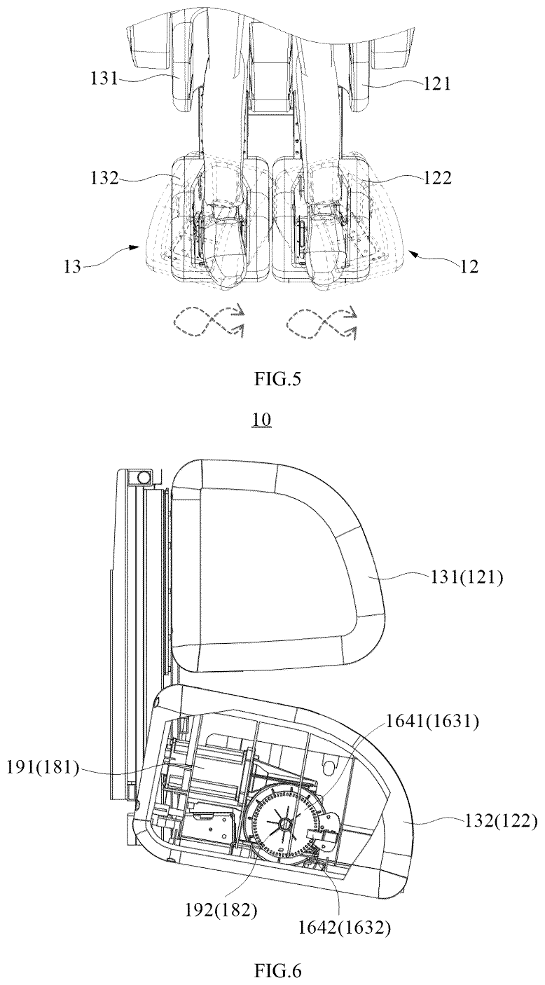

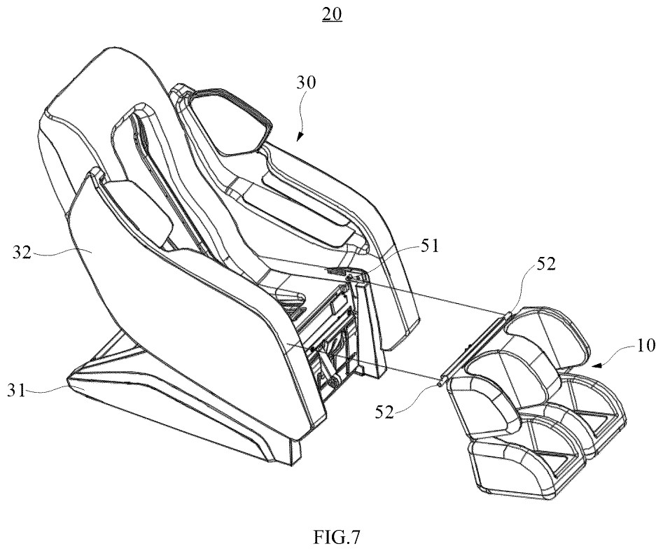

Referring to FIG. 6, the second left drive element includes a left-swinging drive motor 181 and a left-eccentric driving element 182 connected with and driven by the left-swinging drive motor 181, wherein the left foot massager 122 is connected with the left-eccentric driving element 182, and the left-swinging drive motor 181 actuates the left-eccentric driving element 182 to rotate so that the left foot massager 122 swings or rotates as shown by an arrow of FIGS. 4 and 5. The second right drive element includes a right-swinging drive motor 191 and a right-eccentric driving element 192 connected with and driven by the left-swinging drive motor 181, wherein the right foot massager 132 is connected with the right-eccentric driving element 192, and the right-swinging drive motor 191 actuates the right-eccentric driving element 192 to rotate so that the right foot massager 132 swings or rotates as shown by an arrow of FIGS. 4 and 5. The left-eccentric driving element 182 and the right-eccentric driving element 192 are well-known arts, so further remarks are omitted.

The left-foot angle sensing unit includes a left code disc 1631 and a left swing sensor 1632, wherein the left code disc 1631 synchronously rotates with the left-eccentric driving element 182, and the left swing sensor 1632 remains still relative to the left foot massager 122, wherein swinging angle parameters of the left foot massager 122 are learned by using an algorithm of the left encoder, then the swinging angle parameters of the left foot massager 122 are analyzed and processed by the control unit to control a swing of the left foot massager 122 to a fixed position in a fixed time. The right-foot angle sensing unit includes a right code disc 1641 and a right swing sensor 1642, wherein the right code disc 1641 synchronously rotates with the right-eccentric driving element 192, and the right swing sensor 1642 remains still relative to the right foot massager 132, wherein swinging angle parameters of the right foot massager 132 are learned by using an algorithm of the right encoder, then the swinging angle parameters of the right foot massager 132 are analyzed and processed by the control unit to control a swing of the right foot massager 132 to a fixed position in a fixed time.

The left leg-and-foot massage portion 12 and the right leg-and-foot massage portion 13 respectively include at least one massaging element configured to massage the user's legs and feet.

The at least one massaging element is any one of an air bag, a splint, a roller, and a heater. The left leg-and-foot massage portion 12 includes the left leg massager 121 and the left foot massager 122. The right leg-and-foot massage portion 13 includes the right leg massager 131 and the right foot massager 132, wherein the left leg massager 121, the right leg massager 131, the left foot massager 122, and the right foot massager 132 respectively has at least one massaging element, wherein the at least one massaging element is electrically connected with the control unit to massage based on the customized using requirements.

As illustrated in FIG. 7, in application, a massage chair 20 includes a body 30 and the leg-and-foot device 10 connected on the body 30.

The body 30 is configured to support the user and includes at least one massaging element to massage the user's head, shoulder, back, and buttocks.

The control unit of the leg-and-foot device 10 is connected with the at least one massaging element of the body 30 configured to clamp an upper portion of the user's body, the left/right leg-and foot massage portions rotate and the left/right foot massagers stretch and retract or swing to stretch the user's body.

With reference to FIG. 4, in another embodiment, the body 30 includes a holder 31 and a seat 32 rotatably connected on the holder 31, and the leg-and-foot device 10 is rotatably connected on the seat 32. The massage chair 20 further includes a push assembly 40 disposed on the holder 31 and configured to drive the seat 32 to rotate with respect to the holder 31 and/or configured to drive the leg-and-foot device 10 to rotate relative to the seat 32.

The leg-and-foot device 10 is connected on an end of the seat 32, wherein a coupling orifice 51 is defined on the end of the seat 32 to rotatably connect with a bolt 52 of the leg-and-foot device 10.

The push assembly 40 includes a first pushing post 41 configured to push the seat 32, a second pushing post 42, and an abutting stem 43 configured to force the left/right leg-and foot massage portion 12, 13, such that the first pushing post 41 moves to actuate the seat 32 to move vertically, the second pushing post 42 pushes the abutting stem 43 to move vertically, and the abutting stem 43 forces the left/right leg-and foot massage portion 12, 13 to move vertically, hence the left/right leg-and foot massage portions 12, 13 move at different angles with respect to the seat 32.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A leg-and-foot device capable of being driven solely comprising: a base, a left leg-and-foot massage portion, a right leg-and foot massage portion, a first left drive element and a first right drive element which are connected on the base;
wherein a driving segment of the first left drive element is connected with the left leg-and foot massage portion and is configured to drive the left leg-and-foot massage portion to stretch and retract with respect to the base; and
wherein a driving segment of the first right drive element is connected with the right leg-and foot massage portion and is configured to drive the right leg-and-foot massage portion to stretch and retract with respect to the base.

2. The leg-and-foot device as claimed in claim 1, wherein the first left drive element includes a left-moving drive motor, a left screw rod connected with the left-moving motor, and a left screw mating with the left screw rod, wherein the left leg-and-foot massage portion is mounted on the left screw; the first right drive element includes a right-moving drive motor, a right screw rod connected with the right-moving drive motor, and a right screw mating with the right screw rod, wherein the right leg-and-foot massage portion is mounted on the right screw.

3. The leg-and-foot device as claimed in claim 1 further comprising at least one control element which is electrically connected with the first left drive element and the first right drive element to control the left leg-and-foot massage portion and/or the right leg-and-foot massage portion to move.

4. The leg-and-foot device as claimed in claim 3, wherein the at least one control element includes a control unit, a left leg-and-foot length sensing unit and a right leg-and-foot sensing unit; wherein the control unit is electrically connected with the left leg-and-foot length sensing unit, the right leg-and-foot sensing unit, the first left drive element, and the second right drive element; the left leg-and-foot length sensing unit is connected on the left leg-and-foot massage portion and is configured to sense a length of the user's left leg, and the right leg-and-foot length sensing unit is connected on the right leg-and-foot massage portion and is configured to sense a length of the user's right leg.

5. The leg-and-foot device as claimed in claim 3, wherein the left leg-and-foot massage portion includes a left leg massager and a left foot massager, and the right leg-and-foot massage portion includes a right leg massager and a right foot massager;
wherein the leg-and-foot device further comprises a second left drive element and a second right drive element, wherein a driving segment of the second left drive element is connected with the left foot massager so as to drive the left foot massager to swing vertically or rotate with respect to the base; and a driving segment of the second right drive element is connected with the right foot massager so as to drive the right foot massager to swing vertically or rotate with respect to the base.

6. The leg-and-foot device as claimed in claim 5, wherein the at least one control element includes a control unit, a left-foot angle sensing unit and a right-foot angle sensing unit, wherein the control unit is electrically connected with the left-foot angle sensing unit, the right-foot angle sensing unit, the second left drive element, and the second right drive element; wherein the left-foot angle sensing unit is disposed on the left foot massager to sense an angle between an axial line of the left foot massager and an axial line of the left leg massager, and the right-foot angle sensing unit is disposed on the right foot massager to sense an angle between the an axial line of the right foot massager and an axial line of the right leg massager.

7. The leg-and-foot device as claimed in claim 1, wherein the left leg-and-foot massage portion and the right leg-and-foot massage portion respectively include at least one massaging element.

8. The leg-and-foot device as claimed in claim 1, wherein one of the base and the left leg-and-foot massage portion includes a left slide rail, and the other of the base and the left leg-and-foot massage portion includes a left receiving groove mating with the left slide rail; one of the base and the right leg-and-foot massage portion includes a right slide rail, and the other of the base and the right leg-and-foot massage portion includes a right receiving groove mating with the right slide rail.

9. A massage chair comprising a body and the leg-and-foot device of claim connected on the body.

10. The massage as claimed in claim 9, wherein the body includes a holder and a seat rotatably connected on the holder, and the leg-and-foot device is rotatably connected on the seat; the massage chair further includes a push assembly disposed on the holder and configured to drive the seat to rotate with respect to the holder and/or configured to drive the leg-and-foot device to rotate relative to the seat.
